(19) United States
(12) Patent Application Publication
(10) Pub. No.: US 2024/0413956 A1
(43) Pub. Date: Dec. 12, 2024

(54) METHODS AND DEVICES FOR HANDLING INTERFERENCE BETWEEN WIRELESS COMMUNICATIONS NETWORKS

(71) Applicant: Telefonaktiebolaget LM Ericsson (publ), Stockholm (SE)

(72) Inventors: Jingya LI, GÖTEBORG (SE); Thomas CHAPMAN, SOLNA (SE); Zhiqiang QI, BEIJING (CN); Keerthi Kumar NAGALAPUR, GÖTEBORG (SE); Adrián LAHUERTA LAVIEJA, MÖLNDAL (SE)

(73) Assignee: Telefonaktiebolaget LM Ericsson (publ), Stockholm (SE)

(21) Appl. No.: 18/699,223

(22) PCT Filed: Oct. 8, 2021
(86) PCT No.: PCT/CN2021/122543

§ 371 Date: Apr. 5, 2024

(51) Int. Cl. H04L 5/00; H04L 27/00; H04W 16/14

(52) U.S. Cl. CPC H04L 5/0073; H04L 27/0006; H04W 16/14

(57) ABSTRACT

A method is provided to be performed in a device for handling interference between a first wireless communications network and a second communications network. The device is able to switch between the first wireless communications network and the second wireless communications network. The method comprises the device storing, upon detecting the first wireless communications network, a first set of parameters related to the second wireless communications network; attaching to the first wireless communications network; and reporting a second set of parameters to the first network node, wherein the second set of parameters is at least partly based on the first set of parameters.

### TECHNICAL FIELD

The technology disclosed herein relates generally to the field of interference handling in wireless communication, and in particular to methods for handling interference between different wireless communications networks.

### BACKGROUND

There are situations wherein a wireless network needs to be set up as fast as possible. A public safety disaster recovery is one such situation, e.g., when an earthquake, hurricane, wildfire, or other unpredictable event occurs. In such scenarios one or few easily deployable network node(s) may be setup to establish a network, sometimes only a temporary network that temporarily provides wireless coverage and connectivity for a group of authorized users. The users, for instance rescue services, may then swiftly communicate with each other and coordinate rescue operations. Such networks, e.g. temporary networks, typically cover only a limited geographical area, which cannot fully be covered by e.g., a public network (used in the following as exemplary network).

Another example of such scenario is a construction site, where a network may be setup for providing wireless communications for the workers at the construction site having a limited public network coverage. Still another example of such scenario is healthcare in a rural area, where the network may be setup to provide local communications in order to improve the operations for medical personals in that area.

When a network and a public network have overlapping coverage areas it is important to coordinate or otherwise manage the interference between them so as to ensure that the interference will not cause too big impact on the communications for either the users connected only to the public network nor for the authorized users connected to the network.

FIG. 1 illustrate uplink (UL) and downlink (DL) interference situations for the described scenarios. The leftmost part of the figure illustrates the downlink interference situation, and the rightmost figure illustrates the uplink interference situation. The frequency spectrum used for the recently set up network and for the public network can be either the same (co-channel interference, CCI) or different (adjacent channel interference, ACI). These two possibilities may be referred to as CCI and ACI operation scenarios.

In case both the new network and the public network are operating in Frequency Division Duplex (FDD), the DL and UL interference situations are similar to traditional FDD inter-cell interference situations. A first wireless communication device 60 (denoted first User Equipment, UE, 60 in the following) is connected to a base station 64 of the public network, and a second wireless communication device 62 (denoted second UE 62 in the following) is connected to a base station 66 of the new network and used by a rescue person. The first and second UEs 60, 62 receive a respective DL signal (solid lines) from a respective base station 64, 66 as illustrated. These signals are interfered by the signal (dotted lines) from the base station 64, 66 of the opposite network. The UL interference situation is, as mentioned, similar and shown in the rightmost part of FIG. 1 (useful signal shown with solid line and interference signal shown with dotted line).

FIG. 2 illustrates a case wherein at least one of the new network and the public network is in Time Division Duplex (TDD) operation, or wherein both networks are operating in TDD and they are unsynchronized. In such cases there will, in addition to the interference situation shown in FIG. 1, also be cross link interference (CLI) between the two networks 64, 66 (again, useful signal is shown with solid line and interference signal with dotted line). This applies for both the CCI and ACI cases. Two kinds of cross link interference can arise:
inter-UE interference, where one UE 60 transmits in UL whilst another nearby UE 62 is receiving in downlink, and
inter-BS interference, where one BS 64 transmits in DL whilst another BS 66 receives in UL.

Inter-BS interference can be more easily characterized by measurements because base stations do not move in respect to one another. However, it is still not known or predictable when base stations 64, 66 of different networks are transmitting. Inter-UE interference is more difficult to characterize as it may only exist when UEs 60, 62 are close to each other. On the other hand, UEs need to be very close to cause inter-UE interference and, at least for adjacent channel operation, such interference occurs less often than inter-BS interference.

Typically, in order to avoid the CLI issue, synchronization between two public operator networks can be achieved by using a common clock to synchronize to (e.g., a GPS) and a common TDD configuration (typically avoiding simultaneous transmission and reception by different cells). Enforcing such a coordination could, e.g., be performed on an operator voluntary basis or by regulatory requirements. However, if dynamic TDD is supported in one of the public networks, i.e., wherein the DL/UL configurations of network nodes are dynamically changed, such coordination between two public operator networks will become very complex.

CLI handling between a new network and a public network is even more challenging, as there is limited or no coordination between these two networks.

CLI measurements can be used to assist a base station or a network to understand the CLI situation. These measurements can be based on for example the total received signal, e.g., RSSI (Received Signal Strength Indicator), or the received signal strength, e.g., RSRP (Reference Signal Received Power) from a specific (set of) transmitting BSs/UEs. In NR Rel-16, UE-to-UE CLI measurements and reporting was studied and standardized to identify the CLI between different BSs within the same network.

As a new network, in case of a rapidly needed wireless coverage, is typically setup in a fast way without pre-planning, the public network doesn't know when and where the standalone network will be deployed and how it will be configured. In addition, in case the new network is operating in a standalone mode, the new network and the public network cannot communicate with each other. Also, only the authorized UEs can access such standalone deployable network. These issues make it difficult to coordinate and manage the interference between the two networks.

From the above, it is realized that there is a need for improvements in view of serving users, e.g., emergency personnel, while at the same time reducing risks for serious interference between these networks.

### SUMMARY

An objective of the present disclosure is to address and improve various aspects for situations wherein a new network is set up. A particular, exemplary situation is when a temporary network is set up to serve a limited group of persons. A particular objective is to enable a rapid establishment of an interference situation for co-existence of a first network (e.g., a temporary network) and second, existing network (e.g., public network). Still another objective is to improve handling of such interference. These objectives and others are achieved by the methods, devices, computer programs and computer program products according to the appended independent claims, and by the embodiments according to the dependent claims.

These objectives, and others, are according to an aspect achieved by a method, performed in a device, for handling interference between a first wireless communications network and a second communications network. The device is enabled to switch between the first wireless communications network and the second wireless communications network. The first wireless communications network comprises a first network node, which may be a temporarily added network node. The method comprises the device: storing, upon detecting the first wireless communications network, a first set of parameters related to the second wireless communications network; attaching to the first wireless communications network; and reporting a second set of parameters to the first network node, the second set of parameters being at least partly based on the first set of parameters.

The method brings about a number of advantages. For instance, the provided method enables a newly established network to acquire information related to interference from one or more public networks. The acquired information may be based on reports received from the device and the established network may use this information to make proper interference coordination and management decisions in order to better serve its interested/authorized users, while also at the same time mitigate the interference to the public network.

Further features and advantages of the embodiments of the present teachings will become clear upon reading the following description and the accompanying drawings.

### BRIEF DESCRIPTION OF THE DRAWINGS

FIG. 1 illustrates a first interference situation.

FIG. 2 illustrates a second interference situation.

FIG. 3 illustrates an environment in which embodiments according to the present teachings may be implemented.

FIG. 4 is a flow chart of an embodiment of a method in a device in accordance with the present teachings.

FIG. 5 illustrates schematically a device and means for implementing embodiments of the method in a device.

FIG. 6 illustrates a device comprising function modules/software modules for implementing embodiments of the present teachings.

FIG. 7 illustrates an example of a computer program product comprising computer readable storage medium according to an embodiment.

FIG. 8 is a flow chart of an embodiment of a method in a network node in accordance with the present teachings.

FIG. 9 illustrates schematically a device and means for implementing embodiments of a method in a network node.

FIG. 10 illustrates a device comprising function modules/software modules for implementing embodiments of the present teachings.

FIG. 11 illustrates an example of a computer program product comprising computer readable storage medium according to an embodiment.

### DETAILED DESCRIPTION

In the following description, for purposes of explanation and not limitation, specific details are set forth such as particular architectures, interfaces, techniques, etc. in order to provide a thorough understanding. In other instances, detailed descriptions of well-known devices, circuits, and methods are omitted so as not to obscure the description with unnecessary detail. Same reference numerals refer to same or similar elements throughout the description.

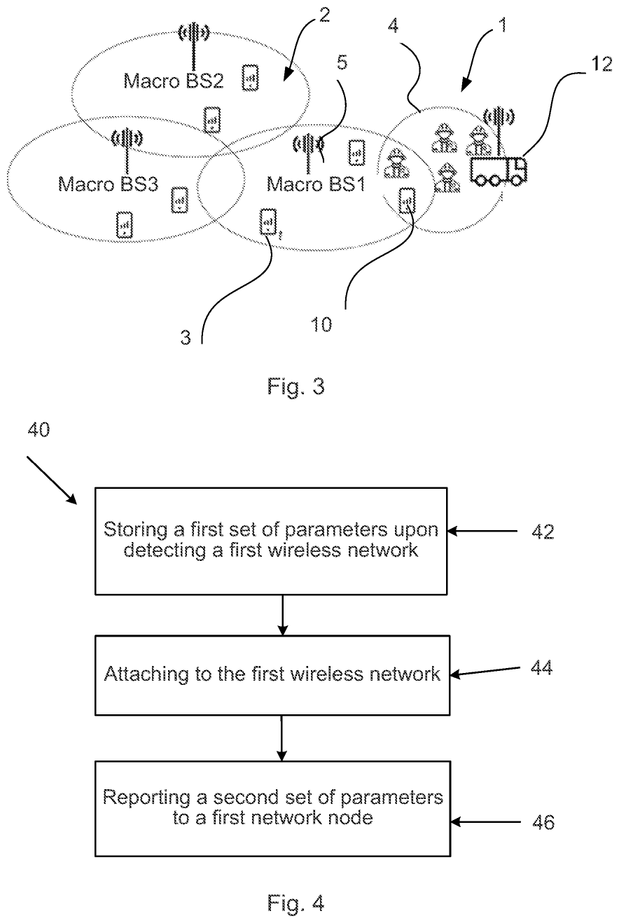

FIG. 3 illustrates an environment in which embodiments according to the present teachings may be implemented. In particular, an exemplary use case is illustrated wherein a temporary wireless network 1 (also denoted simply temporary network 1 in the following) needs to be set up. The temporary wireless network 1 (and correspondingly temporary network node) is used purely as an illustrative example for describing the various features and embodiments according to the present teachings. Thus, it is noted that although a temporary wireless network is used as an example, the wireless network does not actually need to be a temporary network; any network deployed in an area wherein there is a first, already existing network in place, may benefit from the teachings. The illustrated use case is a public safety disaster recovery, where the temporary network 1 (which may also be a public network) is setup for providing mission critical communications to first responders (shown as mission critical (MC) UEs in the FIG. 3). A public network 2 is shown as comprising three different coverage areas (“cells”), each served by a respective macro base station BS1, BS2, BS3. The disaster recovery area is only partly covered by the nearest macro base station BS1 of the public network 2.

The temporary network 1 comprises one or few preferably easily deployable network node(s) 12, which is/are setup to provide the temporary network 1. The main function of the temporary network 1 is to provide coverage and connectivity and/or additional capacity for a group of interested/authorized users within a geographical area of interest. This geographical area of interest is not fully covered by the public network(s) 2.

The temporary network 1 may, in some embodiments, be operating in a standalone mode. In such standalone mode the temporary network 1 does not communication with the public network 2 and the temporary network 1 can only provide local connectivity among users within its coverage. Only the interested/authorized users can access the temporary network 1, while all interested/authorized users that have a subscription are allowed to access the public network 2. In some cases, for instance due to poor radio link conditions to the public network 2, only some of the interested/authorized users can connect to the public network, e.g., whose RSRP related to a macro BS is above a threshold. In other cases, the interested/authorized users can connect to the public network(s) 2, but their Quality of Service (QoS) requirements, e.g., high data rate requirements, cannot be fulfilled by the public network(s) 2. Some of the authorized users may have multi-SIM UEs and thereby be able to connect to both networks simultaneously.

An example of the considered scenario is illustrated in FIG. 3. Two types of UEs are considered in this scenario, conventional UEs 3 and mission critical (MC) UEs 10. The conventional UE 3 is only allowed to access the public network via the macro BSs shown in the figure. The MC UE 10 can access either the public network by connecting to a macro BS or access the newly deployed network by connecting to a deployable BS (or, in the case of a multi-SIM UE, both networks simultaneously).

Although only one newly deployed BS 12 is shown in FIG. 3, the considered scenario can be generalized to the case of multiple nodes. The newly deployed node 12 may be a base station, an Integrated Access and Backhaul (IAB) node, or a relay node. The newly deployed node 12 can be carried on a truck, container, vehicle, or a robot and placed on the ground or indoor; or it can be carried on a drone, Unmanned Aerial Vehicle (UAV), helicopter, balloon, or a non-rigid airship (Blimp) and be placed in the air.

Furthermore, the present teachings can be generalized to a number of networks. In fact, is may also be used for mitigating interference between one or more public networks in a regular, non-emergency situation.

When the temporary network 1 and the public network 2 have overlapping coverage areas, as in the illustrated example, it is important to coordinate/manage the interference between the two networks 1, 2 so as to ensure that the interference will not affect the communications too much for either the users connected (only) to the public network 2 nor for the authorized users connected (only) to the temporary network 1.

The spectrum used for the temporary network 1 and the public network 2 can either be the same, i.e., CCI or different, i.e., ACI. These two possibilities can, as mentioned earlier, be referred to as a CCI operations scenario or an ACI operation scenario.

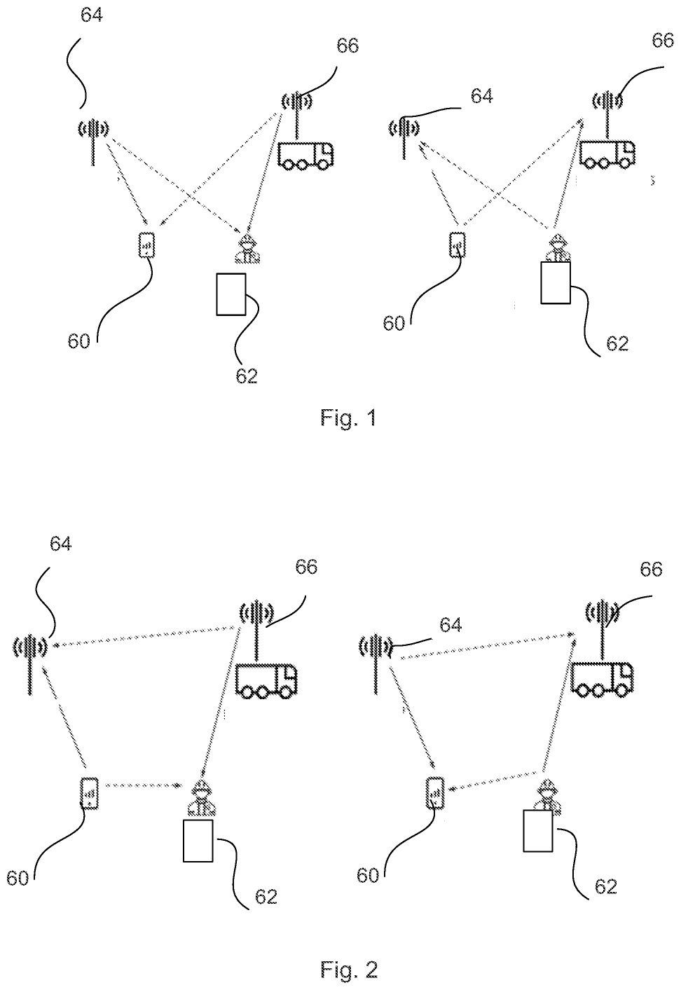

In case both the temporary network 1 and public network 2 are operating in FDD, the DL and UL interference situations are similar to traditional FDD inter-cell interference situations as illustrated in FIG. 1 and described earlier. As also noted earlier the coordination between a temporary network 1 and public network 2 may become very complex, e.g., since the former network 1 often needs to be set up quickly, giving no time for pre-planning, and due to lack of communication and coordination between the networks.

In this description, the terms temporary network, deployable network, and private network are used interchangeable for denoting the newly deployed network. Further, a device 10, e.g., a UE implementing an aspect of the present teachings, is configured to store its interference measurements or/and information related to a previously (or concurrently) connected public network 2 before (or whilst) switching to a temporary network 1, and the device 10, herein exemplified by a UE 10, reports this information to the temporary network 1 in order to assist in the interference identification and interference coordination between the temporary network 1 and the public network 2. It is also noted that the second network 2, exemplified throughout the description as a public network, may be any network, e.g., a private network, the only requirement being that it is a network that is already up and running when the temporary network is deployed.

The UE 10 is a type of UE that is allowed and capable to access at least two networks, e.g. both the public network 2 and the temporary network 1.

The UE 10, which was previously connected to the public network 2 before switching to a temporary network 1, is configured to store its latest interference measurements or/and other information related to the previously connected public network 2. The UE 10 is further configured to report these measurements or information to the temporary network 1.

In other embodiments, the UE 10 may have a multi-Subscriber Identification Modul (SIM) capability and therefore be able to simultaneously connect to both the temporary network 1 and to the public network 2 (or even several public networks). Such UE 10 may further have the capability to make measurements on each network 1, 2 and send information useful for CLI management to/from the other networks.

The measurements/information reported from the UE 10 to the temporary network 1 may, for instance, comprise:
The carrier frequency of the public network 2, or a parameter to indicate if it is a CCI or ACI situation
The operation mode of the public network 2, TDD or FDD, or a parameter to indicate if it is a synchronized or unsynchronized TDD interference case:
   Cell-specific TDD pattern of the public network if it is operating in TDD
The latest timing advance (TA) used for its uplink transition in the public network 2
The latest Angle of Arrival (AoA) and Angle of Departure (AoD) measurements in the public network 2
The latest UL transmission beam information, e.g., the latest UL beam used for transmitting PRACH in the public network 2
The latest Reference Signal Received Power (RSRP), Received Signal Strength Indicator (RSSI), Reference Signal Received Quality (RSRQ) information that it has measured in the public network 2
The UE 10 reporting may, in some embodiments, be performed either during a random access procedure phase before Radio Resource Control (RRC) connection is established. In other embodiments, the UE 10 reporting may be performed after RRC connection setup.

The measurements/information may be used for assisting the temporary network 1 in identifying the interference and make proper interference coordination/management decisions. Such coordination and/or management may, e.g., comprise avoiding scheduling transmissions in potential interfering time/frequency resources, making proper beamforming/power control decisions, adjusting the location of the deployable nodes, etc.

In certain circumstances, a multi-SIM UE might be authorized to not only report measurements, but also to mandate one of the networks to take actions. For example, if the temporary network, e.g., an emergency network, is experiencing interference from the public network, a multi-SIM UE that measures such interference might be authorized to send information to the public network that interference has been recorded and that the public network must take action to mitigate the interference. The prioritization of the temporary network might, for example be allowed by regulators in order to ensure that emergency service coverage is maintained. Alternatively, if the temporary network is not for critical emergency use, the regulator might require the private network to mitigate interference towards the public network so that regular commercial operation is not disrupted.

In case dynamic TDD is deployed and one of the two networks does not use the standard TDD pattern, a multi-SIM UE might measure interference from the network that is not using the standard TDD pattern and send information to the network that interference has arisen and the network must return to using the standard TDD pattern.

In the following, a device 10 that is allowed to access both public network(s) and temporary network is exemplified by a UE 10 and denoted “special UE 10”, while a UE that is only allowed to access the public network 2 is denoted “a conventional UE 3”.

The herein described interference identification scheme comprises the following steps, denoted Step 1, Step 2 and Step 3, but it is noted that they may be performed in a different order than the one described here.

Step 1: A special UE 10 detects a temporary network 1 that fulfills at least one criterion for network switching, and it selects a deployable node 12 of a cell 4 of the temporary network 1 as the cell to camp on.

It is assumed that both the public network 2 and the temporary network 1 are included in a list of network candidates that is pre-stored in the special UE 10, so that the special UE 10 is able to perform network selection and switching between the public and temporary networks. For instance, the public network 2 and the temporary network 1 may be assigned with different Public Land Mobile Network (PLMN) identities, and these identities belong to the list of PLMNs that the special UE 10 may consider when performing network and cell selection.

Network and cell selection may be performed in any known manner. For instance, the network selection may be performed in the automatic mode or in manual mode. The details of how a New Radio (NR) capable UE performs network and cell selection can be found in TS 38.304 Section 5. An LTE based network and cell selection procedure are described in e.g., PLMN Selection in LTE (Idle Mode Action).

Step 2: Before connecting to the selected deployable node of the temporary network 1, the special UE stores a first set of parameters that is related to the current connected public network 2.

The first set of parameters may comprise at least one of the following:
The carrier frequency of the public network
The operation mode of the public network, TDD or FDD.
   Cell-specific TDD pattern of the public network if it is operating in TDD
The latest timing advance (TA) used for its uplink transition in the public network
latest Angle of Arrival (AoA) and Angle of Departure (AoD) measurements in the public network
The latest UL transmission beam information, e.g., the latest UL beam used for transmitting PRACH in the public network
The latest RSRP/RSSI/RSRQ information that it has measured in the public network

For some measurements, e.g., RSRP, RSSI, RSRQ, AoA and AoD, it may be that the special UE 10 does not have the measurement information stored, or that the stored measurement information is outdated (e.g., the duration between the time when the measurement was performed and the time when detecting a temporary network to select is above a threshold). In such cases, the special UE 10 may be triggered to perform a new interference measurement. As an example, one such triggering event may be that the special UE 10 detects a new network to switch to (e.g., to the temporary network 1).

Step 3: The special UE 10 reports a second set of parameters to the temporary network 1 through the selected deployable node/cell 1, 12.

The second set of parameters may be the same as the first set of parameters, or it may be a subset of the parameters contained in the first set.

The second set of parameters may alternatively comprise a parameter that is derived based on a first set parameter and system information obtained from the temporary network 1.

For instance, instead of reporting the carrier frequency of the public network, the special UE 10 reports a parameter to indicate if the interference between temporary network 1 and the public network(s) 2 is a CCI or ACI case. As another example, instead of reporting the operation mode of the public network 2, the special UE 10 may report a parameter to indicate if it is a synchronized or unsynchronized TDD interference case.

The special UE 10 is, in different embodiments, configured to report the second set of parameters to the temporary network either before completion of an RRC connect setup (e.g., report carried on a message during random-access procedure) or after RRC connection established between the selected deployable node/cell of the temporary network.

The reported information can be carried either in a dedicated RRC message, or as part of uplink control information carried on a Physical Uplink Control Channel (PUCCH) or a Physical Uplink Shared Channel (PUSCH).

Signaling of the report configuration (e.g., report format, resource to use for carrying the reports) may be sent from a deployable node/cell 12 to the UE 10 using a system information block (SIB), an RRC message or a Downlink Control Information (DCI) signaling. These are given only as examples, and the signaling from the deployable node 12 to the UE 10 may be sent in still other type of signaling.

The special UE 10 reporting may be triggered by a signaling from the temporary network 1, e.g., using an RRC message or a DCI signaling. In other embodiments, a rule is defined for the type of special UE 10, such that if a certain criterion is satisfied, the special UE 10 will start the reporting procedure automatically. Examples of such criteria comprise:
All special UE(s) 10 that has/have been connected to a public network 2 for a certain time duration before switching to the temporary network 1
All special UE(s) 10 whose RSRP, RSRQ, signal-to-interference-plus-noise ratio (SINR) value is below a certain threshold
Combinations of the above criteria

When using SIB for reporting configuration and triggering, the report configuration and trigging info can be configured such that they are only applicable for certain service or UE types, i.e., only for the interested UEs.

In different embodiments, the temporary network 1 may take one of the following actions for interference handling after receiving the reports from special UEs 10:
Adjust its antenna configuration (e.g., electrical tilt, beamforming directions) to avoid causing serious interference to public networks 2
Adjust the DL/UL transmit power when transmitting signals on potential interfering time/frequency resources
Avoid scheduling data transmission on potential interfering time/frequency resources
Adjust the 2-D or 3-D location of the deployable nodes

In some embodiments, the special UE 10 may be configured in still further ways. The temporary network 1 may, for instance, configure the connected special UE 10 to switch back to connect to the public network 1 and report the interference and system information of the temporary network 1. Thereby, the special UE 10 assists the public network 2 in identifying the interference situation and make proper interference handling decisions. Similar reporting parameters as discussion earlier may be considered here.

In other embodiments, the special UE 10 comprises multiple-SIM, so that it is able to connect to both the public network 2 and to the temporary network 1 simultaneously and continuously report measurements.

In still other embodiments, the special UE 10 may be enabled to report interference measurements to the network that is creating the interference. Such report may comprise a requirement (implicit or explicit) for the network to take steps to mitigate the interference. An example of such a step is that the interfering network should cease applying dynamic TDD and return to a general TDD pattern. Another example is that the interfering network should stop transmitting in certain directions and/or in certain slots.

Although the teachings primarily envisage a private network and a public network, it may also be applied in a scenario of two or more public networks on adjacent channels.

The described embodiments may be combined in many different ways, examples of which are given in the following.

FIG. 4 is a flow chart of an embodiment of a method in a device in accordance with the present teachings. A method 40 is thus provided, which is to be performed in a device 10 for handling interference between a first wireless communications network 1 and a second communications network 2. The device 10 is able to switch between the first wireless communications network 1 and the second wireless communications network 2. The first wireless communications network 1 comprises a newly added first network node 12. The method 40 comprises the device 10 performing a number of steps.

The method 40 comprises storing 42, upon detecting the first wireless communications network 1, a first set of parameters related to the second wireless communications network 2.

The method 40 comprises attaching 44 to the first wireless communications network 1.

The method 40 comprises reporting 46 a second set of parameters to the first network node 12, the second set of parameters being at least partly based on the first set of parameters.

In an embodiment, the reporting 46 is performed upon receiving signaling from the first network node 12 of the first wireless communications network 1. Such signaling may, for instance comprise a report configuration (e.g., report format or resource to use for sending the reports) or other known signaling.

In an embodiment, the reporting 46 is performed based on fulfillment of a criterion, the criterion comprising one or both of: the device 10 having been connected to the second wireless network 2 for a predefined time period and the device 10 fulfilling an interference related value.

In various embodiments, the reporting 46 comprises a requirement for the first wireless communications network 1 to take interference mitigation actions.

In various embodiments, the method 40 comprises the device 10 sending instructions to a network node 5 of the second wireless communications network 2 to take interference mitigation actions.

In variations of the above embodiment, the interference mitigation action is one or more of: adjusting a 2D or 3D location of the network node 5, ceasing applying dynamic Time Division Duplex, TDD, and returning to a general TDD pattern, stop transmitting in defined direction, strop transmitting in defined time slots, adjusting antenna configurations, and adjusting transmit power.

In various embodiments, the first set of parameters comprises one or more of: a carrier frequency of the second wireless communications network, operation mode (for instance TDD or FDD), Time Division Duplex pattern, Angle of Departure, Angle of Arrival, Timing Advance, uplink transmission beam information, Reference Signal Received Power, Reference Signal Strength Indicator, Reference Signal Received Quality, Signal to Interference and Noise ratio.

In a variation of the above embodiment, the second set of parameters is identical to the first set of parameters.

In various embodiments, the second set of parameters comprises a subset of parameters of the first set of parameters.

In variations of the above set of embodiments, at least one parameter of the second set of parameters is derived from the first set of parameters.

In various embodiments, the first wireless communications network 1 operates in a standalone mode with local connectivity and to which only authorized devices and/or services have access.

In various embodiments, the first wireless communications network 1 is a temporary deployable network, and the second wireless communications network 2 is a public communications network.

A device 10 is also provided, as has been described. The device 10 may be used for handling interference between a first wireless communications network 1 and a second communications network 2. The device 10 is able to switch between the first wireless communications network 1 and the second wireless communications network 2, i.e., switch from the first network node 12 of the first wireless communications network 1 to a network node BS1, BS2, BS3 of the second wireless communications network 2, and vice versa. The device 10 may be enabled to switch between the networks 1, 2 by, for instance, using an explicit control signaling sent from the serving BS or by reducing the transmit power of the control channels to the device 10 (upon which the device 10 switches to the BS having highest transmit power). The first wireless communications network 1 comprises a newly added first network node 12. The device 10 is configured to store, upon detecting the first wireless communications network 1, a first set of parameters related to the second wireless communications network 2. The device 10 is configured to attach to the first wireless communications network 1. The device 10 is configured to report a second set of parameters to the first network node 12, wherein the second set of parameters is at least partly based on the first set of parameters.

In an embodiment, the device 10 is configured to report upon receiving signaling from the first network node 12 of the first wireless communications network 1.

In an embodiment, the device 10 is configured to report a requirement for the first wireless communications network 1 to take interference mitigation actions.

In various embodiments, the device 10 is configured to send instructions to a network node of the second wireless communications network 2 to take interference mitigation actions.

In various embodiments, the first set of parameters comprises one or more of: a carrier frequency of the second wireless communications network, operation mode (e.g., TDD or FDD), Time Division Duplex pattern, Angle of Departure, Angle of Arrival, Timing Advance, UL transmission beam information, Reference Signal Strength Indicator, Reference Signal Received Quality, Signal to Interference and Noise Ratio and Reference Signal Received Power.

In variations of the above set of embodiments, the second set of parameters is identical to the first set of parameters. In such embodiments, the device 10 is alleviated from performing any post-data process on its interference measurements.

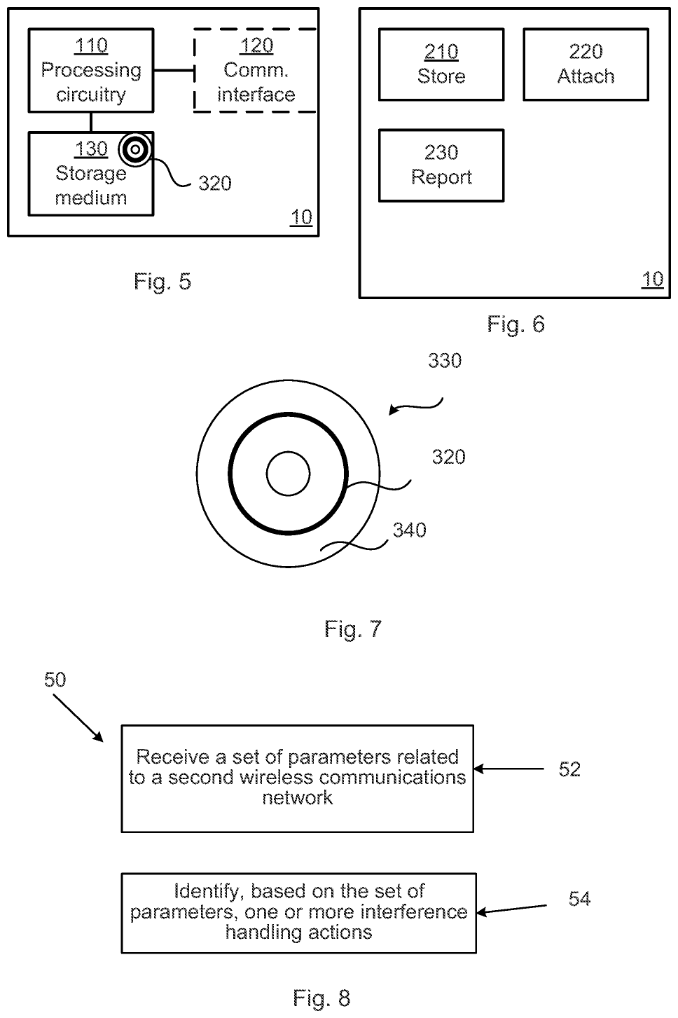

FIG. 5 is a schematic diagram showing functional units of a device according to embodiments. The functional units 110, 120, 130 may, for instance, be embodied as a controller arranged in the device 10. That is, each functional unit is part of such controller, which controller in turn is arranged in the device 10.

Processing circuitry 110 is provided using any combination of one or more of a suitable central processing unit (CPU), multiprocessor, microcontroller, digital signal processor (DSP), etc., capable of executing software instructions stored in a computer program product 330 (as in FIG. 7), e.g., in the form of a storage medium 340. The processing circuitry 110 may further be provided as at least one application specific integrated circuit (ASIC), or field programmable gate array (FPGA).

Particularly, the processing circuitry 110 is configured to cause the controller to perform a set of operations, or steps, as disclosed above. For example, the storage medium 130 may store the set of operations, and the processing circuitry 110 may be configured to retrieve the set of operations from the storage medium 130 to cause the controller to perform the set of operations causing the device 10 to, for instance, store, upon detecting a first wireless communications network, a first set of parameters related to the second wireless communications network, to attach to the first wireless communications network, and to report a second set of parameters to the first network node, the second set of parameters being at least partly based on the first set of parameters. The set of operations may be provided as a set of executable instructions.

FIG. 6 schematically illustrates, in terms of a number of functional modules, the components of a device 10 according to an embodiment. The device 10 of FIG. 6 comprises a number of functional modules; a store module 210 configured to perform step 42, an attach module 220 configured to perform step 44, and a report module 230 configured to perform step 46. The device 10 of FIG. 6 may further comprise a number of optional functional modules, such as a sending module (not illustrated) configured to send instructions to a network node of the second wireless communications network to take interference mitigation actions. In general terms, each functional module 210, 220, 230 may in one embodiment be implemented only in hardware and in another embodiment with the help of software, i.e., the latter embodiment having computer program instructions stored on the storage medium 130 which when run on the processing circuitry makes the device 10 perform the corresponding steps mentioned above in conjunction with FIG. 5. It should also be mentioned that even though the modules correspond to parts of a computer program, they do not need to be separate modules therein, but the way in which they are implemented in software is dependent on the programming language used. Preferably, one or more or all functional modules 210, 220, 230 may be implemented by the processing circuitry 110, possibly in cooperation with the communications interface 120 and/or the storage medium 130. The processing circuitry 110 may thus be configured to from the storage medium 130 fetch instructions as provided by a functional module 210, 220, 230 and to execute these instructions, thereby performing any steps as disclosed herein.

FIG. 7 shows an example of a computer program product 330 comprising computer readable storage medium according to an embodiment. On this computer readable storage medium 330, a computer program 320 can be stored, which computer program 320 can cause the processing circuitry 110 and thereto operatively coupled entities and devices, such as the communications interface 120 and the storage medium 130, to execute methods according to embodiments described herein. The computer program 320 and/or computer program product 330 may thus provide means for performing any steps as herein disclosed.

In the example of FIG. 7, the computer program product 330 is illustrated as an optical disc, such as a CD (compact disc) or a DVD (digital versatile disc) or a Blu-Ray disc. The computer program product 330 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 320 is here schematically shown as a track on the depicted optical disk, the computer program 320 can be stored in any way which is suitable for the computer program product 330.

FIG. 8 is a flow chart of an embodiment of a method in a newly added network node in accordance with the present teachings. A method 40 is thus provided, which is to be performed in a newly added network node 12, e.g., a temporarily deployed network node 12.

The method 50 is to be performed in a first network node 12 of a first wireless communications network 1 for interference identification and coordination towards a second wireless communications network 1. The first wireless communications network 1 is a newly added network (i.e., deployed after establishment of the second wireless communications network 1), which, in some embodiments, operates in a standalone mode and provides only local connectivity and to which only authorized devices have access. The method 50 comprises receiving 52, from a device 10, a set of parameters related to a second wireless communications network 2.

The method 50 comprises identifying 54, based on the set of parameters, one or more interference handling actions.

When deploying a new conventional BS, its location is carefully considered, taking various aspects into consideration such as, for instance, distances to nearby buildings, to other base stations, possible interference sources etc. The conventional, stationary base station is hence situated at a pre-planned fixed location. In contrast, in some situations, the location of a temporary deployable base stations has to be decided more or less “on the fly”. By providing the deployable base station 12 with means for taking interference handling actions (e.g., sending instructions to the nearest fixed base station to alter, e.g., its antenna settings), the best possible location for the deployable base station 12 can be obtained. Another interference handling action may be to adjust the deployable base station's 3-D location, based, for instance, on measurements made to the closest base station(s). The best possible location may thereby be obtained, and it may also be improved, possibly in an iterative manner.

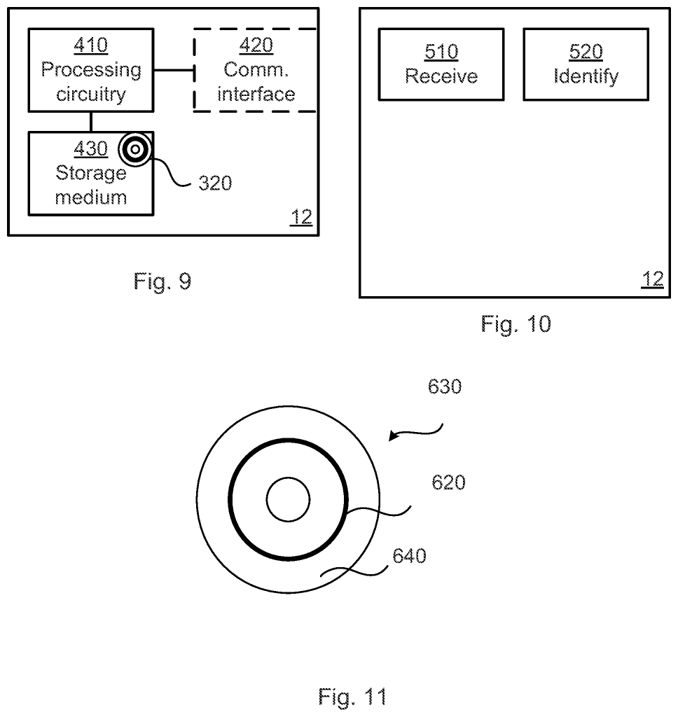

FIG. 9 is a schematic diagram showing functional units of a device according to embodiments. The functional units 410, 420, 430 may, for instance, be embodied as a controller arranged in a temporary network node 12. That is, each functional unit is part of such controller, which controller in turn is arranged in the temporary network node 12.

Processing circuitry 410 is provided using any combination of one or more of a suitable central processing unit (CPU), multiprocessor, microcontroller, digital signal processor (DSP), etc., capable of executing software instructions stored in a computer program product 630 (as in FIG. 11), e.g., in the form of a storage medium 430. The processing circuitry 410 may further be provided as at least one application specific integrated circuit (ASIC), or field programmable gate array (FPGA).

Particularly, the processing circuitry 410 is configured to cause the controller to perform a set of operations, or steps, as disclosed above. For example, the storage medium 430 may store the set of operations, and the processing circuitry 410 may be configured to retrieve the set of operations from the storage medium 430 to cause the controller to perform the set of operations causing the temporary network node 12 to, for instance, receive, from a device 10, a set of parameters related to a second wireless communications network 2, and to identifying, based on the set of parameters, one or more interference handling actions. The set of operations may be provided as a set of executable instructions.

FIG. 10 schematically illustrates, in terms of a number of functional modules, the components of a first network node 12 according to an embodiment. The first network node 12 of FIG. 10 comprises a number of functional modules; an receive module 510 configured to perform step 52, and an identify module 520 configured to perform step 54. The first network node 12 of FIG. 10 may further comprise a number of optional functional modules, such as a sending module (not illustrated) configured to send instructions to a device 10 operating in the first wireless communications network, or send instructions to a conventional base station BS1, BS2, BS3 to take interference mitigation actions. In general terms, each functional module 510, 520 may in one embodiment be implemented only in hardware and in another embodiment with the help of software, i.e., the latter embodiment having computer program instructions stored on the storage medium 430 which when run on the processing circuitry makes the temporary network node 12 perform the corresponding steps mentioned above in conjunction with FIG. 9. It should also be mentioned that even though the modules correspond to parts of a computer program, they do not need to be separate modules therein, but the way in which they are implemented in software is dependent on the programming language used. Preferably, one or more or all functional modules 510, 520 may be implemented by the processing circuitry 410, possibly in cooperation with the communications interface 420 and/or the storage medium 430. The processing circuitry 410 may thus be configured to from the storage medium 430 fetch instructions as provided by a functional module 510, 520 and to execute these instructions, thereby performing any steps as disclosed herein.

FIG. 11 shows an example of a computer program product 630 comprising computer readable storage medium according to an embodiment. On this computer readable storage medium 630, a computer program 620 can be stored, which computer program 620 can cause the processing circuitry 410 and thereto operatively coupled entities and devices, such as the communications interface 420 and the storage medium 430, to execute methods according to embodiments described herein. The computer program 620 and/or computer program product 630 may thus provide means for performing any steps as herein disclosed.

In the example of FIG. 11, the computer program product 630 is illustrated as an optical disc, such as a CD (compact disc) or a DVD (digital versatile disc) or a Blu-Ray disc. The computer program product 630 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 620 is here schematically shown as a track on the depicted optical disk, the computer program 620 can be stored in any way which is suitable for the computer program product 630.

The invention has mainly been described herein with reference to a few embodiments. However, as is appreciated by a person skilled in the art, other embodiments than the particular ones disclosed herein are equally possible within the scope of the invention, as defined by the appended patent claims.

1. A method performed in a device for handling interference between a first wireless communications network and a second communications network, the device being able to switch between the first wireless communications network and the second wireless communications network, the first wireless communications network comprising a first network node the method comprising:
storing, upon detecting the first wireless communications network, a first set of parameters related to the second wireless communications network;
attaching to the first wireless communications network; and
reporting a second set of parameters to the first network node, the second set of parameters being at least partly based on the first set of parameters.

2. The method of claim 1, wherein the reporting is performed upon receiving signaling from the first network node of the first wireless communications network.

3. The method of claim 1, wherein the reporting is performed based on fulfillment of a criterion, the criterion comprising one or both of: the device having been connected to the second wireless network for a predefined time period and the device fulfilling an interference related value.

4. The method of claim 1, wherein the reporting comprises a requirement for the first wireless communications network to take interference mitigation actions.

5. The method of claim 1, comprising the device sending instructions to a network node of the second wireless communications network to take interference mitigation actions.

6. The method of claim 5, wherein the interference mitigation action is one or more of: adjusting a 2D or 3D location of the network node, ceasing applying dynamic Time Division Duplex, TDD, and returning to a general TDD pattern, stop transmitting in defined direction, strop transmitting in defined time slots, adjusting antenna configurations, and adjusting transmit power.

7. The method of claim 1, wherein the first set of parameters comprises one or more of: a carrier frequency of the second wireless communications network, operation mode such as Time Division Duplex or Frequency Division Duplex, Time Division Duplex pattern, Angle of Departure, Angle of Arrival, Timing Advance, uplink transmission beam information, Reference Signal Strength Indicator, Reference Signal Received Quality, Signal to Interference and Noise Ratio and Reference Signal Received Power.

8. The method of claim 7, wherein the second set of parameters is identical to the first set of parameters.

9. The method of claim 1, wherein the second set of parameters comprises a subset of parameters of the first set of parameters.

10. The method of claim 9, wherein at least one parameter of the second set of parameters is derived from the first set of parameters.

11. The method of claim 1, wherein the first wireless communications network operates in a standalone mode with local connectivity and to which only authorized devices and/or services have access.

12. The method of claim 1, wherein the first wireless communications network is a temporary deployable network, and the second wireless communications network is a public communications network.

13. A device for handling interference between a first wireless communications network and a second communications network, the device being able to switch between the first wireless communications network and the second wireless communications network, the first wireless communications network comprising a first network node, and the device further being configured to:
store, upon detecting the first wireless communications network, a first set of parameters related to the second wireless communications network;
attach to the first wireless communications network; and
report a second set of parameters to the first network node, the second set of parameters being at least partly based on the first set of parameters.

14. The device of claim 13, configured to report upon receiving signaling from the first network node of the first wireless communications network.

15. The device of claim 13, configured to report a requirement for the first wireless communications network to take interference mitigation actions.

16. The device of claim 13, configured to send instructions to a network node of the second wireless communications network to take interference mitigation actions.

17. The device of claim 13, wherein the first set of parameters comprises one or more of: a carrier frequency of the second wireless communications network, operation mode such as Time Division Duplex or Frequency Division Duplex, Time Division Duplex pattern, Angle of Departure, Angle of Arrival, Timing Advance, uplink transmission beam information, Reference Signal Strength Indicator, Reference Signal Received Quality, Signal to Interference and Noise Ratio and Reference Signal Received Power.

18. (canceled)

19. A non-transitory computer readable storage medium storing a computer program, the computer program comprising computer program code, which, when run on processing circuitry of a device causes the device to perform the method of claim 1.

20. (canceled)

21. A method performed in a first network node of a first wireless communications network for interference identification and coordination towards a second wireless communications network, the first wireless communications network being a temporarily added network operating in a standalone mode with local connectivity and to which only authorized devices have access, the method comprising:
receiving, from a device, a set of parameters related to a second wireless communications network,
identifying, based on the set of parameters, one or more interference handling actions.

22. A non-transitory computer readable storage medium storing computer program, the computer program comprising computer program code, which, when run on processing circuitry of a first network node causes the first network node to perform the method of claim 21.

23-24. (canceled)
